(19) United States
(12) Patent Application Publication
(10) Pub. No.: US 2004/0010470 A1
(43) Pub. Date: Jan. 15, 2004

(54) Anti-piracy system for software and digital entertainment

(76) Inventor: Charles A. Mills, The Sea Ranch, CA (US)

Correspondence Address: Edwin H. Taylor, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/192,185

(22) Filed: Jul. 9, 2002

(51) Int. Cl. G06F 17/60

(52) U.S. Cl. 705/51

(57) ABSTRACT

An invention for protecting intellectual property in digital form from unauthorized sharing, transfer and re-distribution. Examples of intellectual property that might be protected by the invention are computer programs, music, movies, e-books and video games. The invention operates by requiring for the successful installation, use or enjoyment of the intellectual property some piece of information such as a credit card number that an authorized user has provided to the intellectual property publisher, but is generally unwilling to disclose to acquaintances, associates, and others. Unauthorized individuals who might receive a copy of the intellectual property are therefore unable to make use of it because they do not have the enabling piece of information that the authorized user is unwilling to share. Thus, unauthorized sharing, transfer, and re-distribution of the intellectual property are precluded.

### FIELD OF THE INVENTION

This invention relates to systems and methods for preventing piracy, unauthorized sharing and illicit use of software and entertainment distributed in digital form. More particularly, this invention relates to systems and methods that allow software and digital entertainment to be installed, used, operated, played, or viewed only by a person who possesses a piece of information that the legitimate user or licensee of the software or digital entertainment is not willing to divulge or share, thereby preventing the legitimate user from sharing access to his or her licensed software or digital entertainment.

### DESCRIPTION OF PRIOR ART

Computer software and digital entertainment differs from other consumer products in that it may be duplicated by the purchaser at little or no cost. A seller of automobiles or vegetables is hardly concerned that the purchaser will make a copy of the product and give it to a friend—but unauthorized duplication is a major concern for software and music publishers, according to testimony by Michael D. Eisner, chairman of Walt Disney Company, before the U. S. Senate Commerce Committee on Feb. 28, 2002 (quoted in an article in the Business Section of the New York Times on March 1). The fear of rampant illicit sharing is said to be a major concern holding back the digital distribution of music and movies, according to the “New Economy” column of the New York Times on Apr. 8, 2002, and by extension the spread of broadband access to the Internet. In fact, the recent collapse of the telecommunications industry is said to have been caused partially by the failure of consumers to adopt broadband because publishers, for fear of piracy, were holding back digital content.

While the terms of the licenses under which software and recorded entertainment is sold typically prohibit duplication, an unscrupulous party can obtain a copy of the software or entertainment and then illicitly replicate and resell pirated copies of the product. Although illicit copying and distribution has been a problem since the dawn of published works, the problem is much worse with digital works because it is possible to make perfect copies rapidly using common computer equipment—unlike earlier media where copies often had to be made slowly and individually, and were of inferior quality to the legitimately published works.

The piracy of software and other intellectual property can take many forms. At the most severe extreme are illicit duplicating operations that mimic legitimate software companies, producing professional quality counterfeit media and packaging. At the other end are legitimate users who “stretch” the terms of a license agreement such as small businesses that purchase a single-user license and then allow two or three employees to use it. Somewhere in the middle is the legitimate purchaser who then “shares” the license with others, either one or two friends, or by posting the software or access key on a computer bulletin board, listserver, or web site.

Software and entertainment companies attempt to monitor piracy activities, but detection is often difficult. Moreover, enforcement and legal recourse is often impractical, particularly since numerous individuals each engaged in only small-scale piracy perpetrate much of the abuse. So software and entertainment publishers have an incentive to use technological tools to prevent or discourage illicit duplication and sharing. Any such technological tools must not only be effective against illicit duplication, they must also be easy for a non-technological person to use, should permit legitimate copies such as system backup and recovery, and must not unduly hamper legitimate usage or discourage customers from buying the product.

The earliest technological tool used in an attempt to prevent sharing was copy protection. Software distribution diskettes were engineered with features to prevent the software from being installed more than once. Copy protection has fallen into disuse for a number of reasons, primarily because of severe customer resistance to the inconvenience of not being able to re-install software legitimately, such as after a hard disk “crash” or the purchase of a new computer, and the trend toward software distribution on CDs, which are not suitable for some methods of copy protection because the installation program cannot write back onto the CD to indicate that the software has already been installed once (or the number of times allowed by the license).

More recently, software publishers have sought to hinder commercial-scale software piracy operations through the use of distinctive, hard-to-counterfeit packaging features such as holograms. Packaging-based methods are obviously of limited effectiveness, are incompatible with Internet-distributed software, and have no value in protecting against the licensed user who shares software or other intellectual property with others.

The most common anti-piracy technique in use today is the installation key. The software or other intellectual property is designed and implemented to require a key (a number or alphanumeric string of twenty or so characters) in order to be installed successfully. The key must satisfy some validation algorithm—not every number or string of the requisite number of characters works—but the pattern is made intentionally non-obvious to a potential installer. A valid key must be obtained from the media packaging, or in a more secure approach, the publisher e-mails a valid key only to a customer who actually pays for the software or identifies himself as a legitimate licensee. This prior art anti-piracy technique is illustrated in FIG. 1.

The installation key method is of no effectiveness in preventing “sharing,” illicit transfers or re-distribution—the user who makes the software available to others simply makes the key—obtained with his or her legitimate purchase of the software—available at the same time. In fact, for Internet-distributed software, a person who wishes to share a license illegitimately need only make the key available to his friends, associates, and acquaintances—they can download the software themselves.

Another piracy prevention device in use today is the “dongle” (U.S. Pat. No. 5,692,917 granted Dec. 2, 1997 to Rieb, Miller and Foreman). Dongles are hardware devices inserted on a computer port, typically the printer port, between the computer and the normally attached device. The software queries the dongle for authorization. Unauthorized usage is prevented because the dongle is not easily replicated. Dongles have the disadvantage of adding cost and complexity to software licenses, and are unpopular with customers because of the inconvenience and the possibility of a dongle hardware failure rendering their software unusable. Dongles are also unsuitable for use in the electronic grant of licenses over the Internet.

U.S. Pat. No. 6,243,468 granted Jun. 5, 2001 to Pearce and Hughes discloses an anti-piracy system that depends on the differences among computer hardware configurations to prevent the illicit replication of software from one machine to another. U.S. Pat. No. 6,243,468 improves on earlier inventions (such as U.S. Pat. No. 5,199,066 granted Mar. 30, 1993 to Logan) by treating limited changes in the computer's configuration as a permitted hardware upgrade, but assuming that extensive differences indicate a different machine on which the licensed software is then not permitted to operate. U.S. Pat. No. 6,243,468 is of no value in preventing license sharing among users with identical machines. Mass merchandisers such as Costco sell hundreds or thousands of identically configured machines. Furthermore, unlike the present invention, U.S. Pat. No. 6,243,468 is of little or no use in protecting intellectual property commonly used with machines that typically have relatively few hardware customization options, such as Personal Digital Assistants and personal media players. In addition, U.S. Pat. No. 6,243,468 depends on a subtle “tuning” of its threshold of permitted differences: set the tolerance too high, and it permits licenses to be shared among friends with merely similar machines; set the tolerance too low, and it angers honest customers by disabling software after a hard drive or memory upgrade. The present invention instead makes a simple “yes or no” decision: does the proposed user have a particular piece of information belonging to the legitimate licensee?

U.S. Pat. No. 6,385,596 granted May 7, 2002 to Wiser et. al. describes an Internet digital music distribution system that includes as one aspect the possible display of a credit card number or other confidential information on the music player, as a way of preventing the sharing of the “digital passport” that represents the right to play the downloaded music. The present invention is suitable to protecting from piracy computer software as well as all kinds of digital media, not just digital music and related files. Furthermore, the present invention is superior in that the credit card number or other private information must be affirmatively typed by the prospective user, rather than simply being displayed in his presence. The inventor believes that this constitutes stronger protection. Also, in the present invention the private information may be typed privately and need not be displayed for others to see. The inventor believes that many people would be unwilling to use a music player that displayed their credit card number for others to see.

### SUMMARY OF THE INVENTION

The invention is a method of, and a software product for, protecting intellectual property from unauthorized sharing, transfer, or re-distribution. It operates by requiring for the successful installation, use, or enjoyment of the intellectual property some piece of information that an authorized user is generally unwilling to disclose to acquaintances, associates, and others. Those individuals who might receive a copy of the intellectual property are therefore unable to make use of it because they do not have the enabling piece of information that the authorized user is unwilling to share.

The private information that is at the crux of this invention could be any piece of information that met the following criteria:

1. Most people would be unwilling to share it generally, but would be willing to divulge it as part of a purchase transaction. An example is one's year of birth.

2. The information must be specific, and of a sufficient number of digits or characters that it cannot be readily guessed. This requirement eliminates year of birth, for example—it is trivial to guess someone's year of birth with some small number of attempts.

3. The publisher of the intellectual property must be able to validate the information, so that a person cannot defeat the system by giving some information that is fictional, and therefore freely shareable. For example, in some countries, a social security number might satisfy this requirement.

The piece of information that easily fulfills all of these requirements is a credit card number. Most people are ferociously protective of the secrecy of their credit card numbers, but expect to divulge a credit card number as a part of many commercial transactions. Credit card numbers are typically 15 or 16 digits and cannot be readily guessed. And vendors routinely validate credit card numbers as a part of sales transactions. Few people are willing to share their credit card numbers with acquaintances, let alone share them with hackers around the world by posting them on Internet message boards.

The invention can operate in either of two basic modes. In the first mode, the intellectual property is distributed in a form that requires the entry of the private information and a corresponding publisher-supplied key. The publisher provides a legitimate purchaser with a key derived in such a way that it functions only in conjunction with the exact private information originally supplied as part of the purchase.

In the second mode of operation, the intellectual property is encrypted by the publisher using an encryption key that is, or is derived from, the piece of private information. A prospective user can decrypt it successfully only with the original private information.

### BRIEF DESCRIPTION OF THE DRAWINGS

FIG. 1 is a flow diagram showing prior art, in which a validation key that is not specific to any customer private information is provided to the customer.

FIG. 2 is a flow diagram showing steps of an exemplary method of using the invention in the mode of a publisher-generated key that is derived from and is validated by the private information.

FIG. 3 is a flow diagram showing detail of the use of a hashing function to derive a key from the private information and the Product ID.

FIG. 4 is a flow diagram showing steps of an exemplary distribution method using the invention in the mode in which a publisher encrypts the intellectual property product with a key derived from the private information.

FIG. 5 is a block diagram of an exemplary anti-piracy system that uses the invention in the mode of a publisher-generated key that is derived from and is validated by a credit card number.

FIG. 6 is a block diagram of an exemplary anti-piracy system that uses the invention in the mode in which a publisher encrypts the intellectual property with a key derived from a credit card number.

FIG. 7 illustrates the user interface of a combined browser and player that embodies the invention in the mode in which a publisher encrypts the intellectual property product with a key derived from a credit card number.

### DETAILED DESCRIPTION

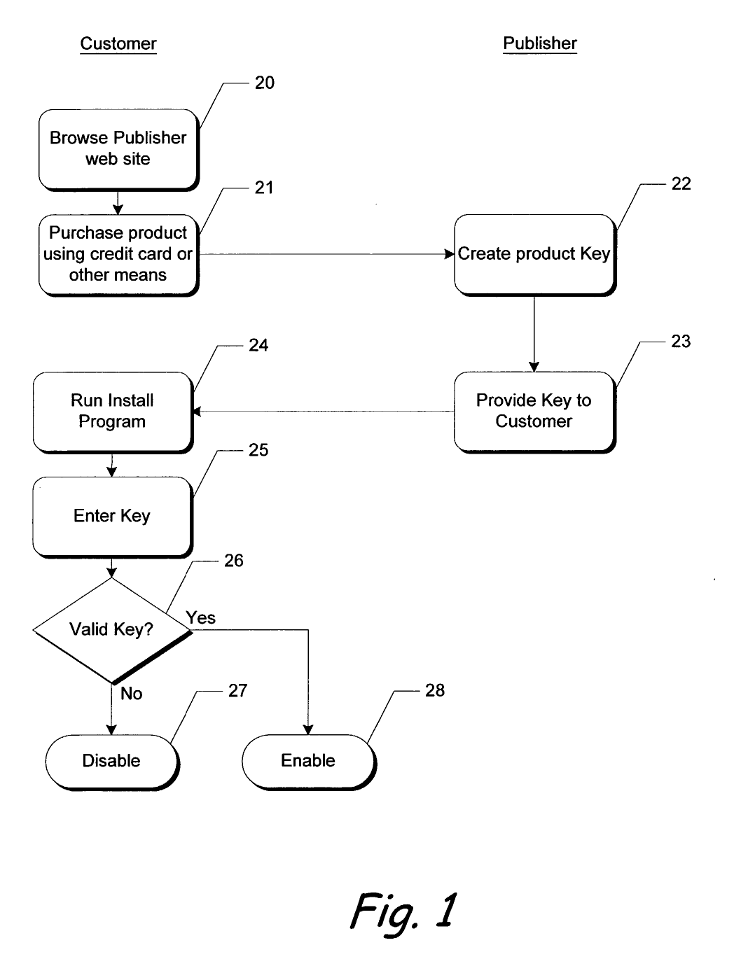

FIG. 1 shows the prior art of a method of a customer purchasing an intellectual property product license from a publisher who uses a publisher-supplied key that serves to enable the product, but that does not require any private information to prevent unauthorized sharing. The customer browses the publisher's web site 20 and decides to purchase a license for the product. The customer purchases a license for the product using a credit card or other means 21. The publisher's web software generates a Key that is specific to the product being purchased and includes internal validation information such as a checksum 22. The publisher's web software displays the Key to the customer or e-mails it to the customer 23. The product itself could be downloaded by the customer, or could be made available to the customer by other means, such as a CD. The customer runs the product's installation program 24. The installation program prompts the customer for the publisher-supplied Key 25. The installation program validates the Key and checks that is for the correct product 26. If the Key is not valid (i.e., the “No” branch from 26) and operation or usage of the product is disabled 27. If the Key is valid (i.e., the “Yes” branch from 26) and operation or usage of the product is enabled 28. There is no barrier to an unscrupulous person's sharing the product and installation Key with others, or even posting the key on a hacker web site for hundreds or thousands of others to use.

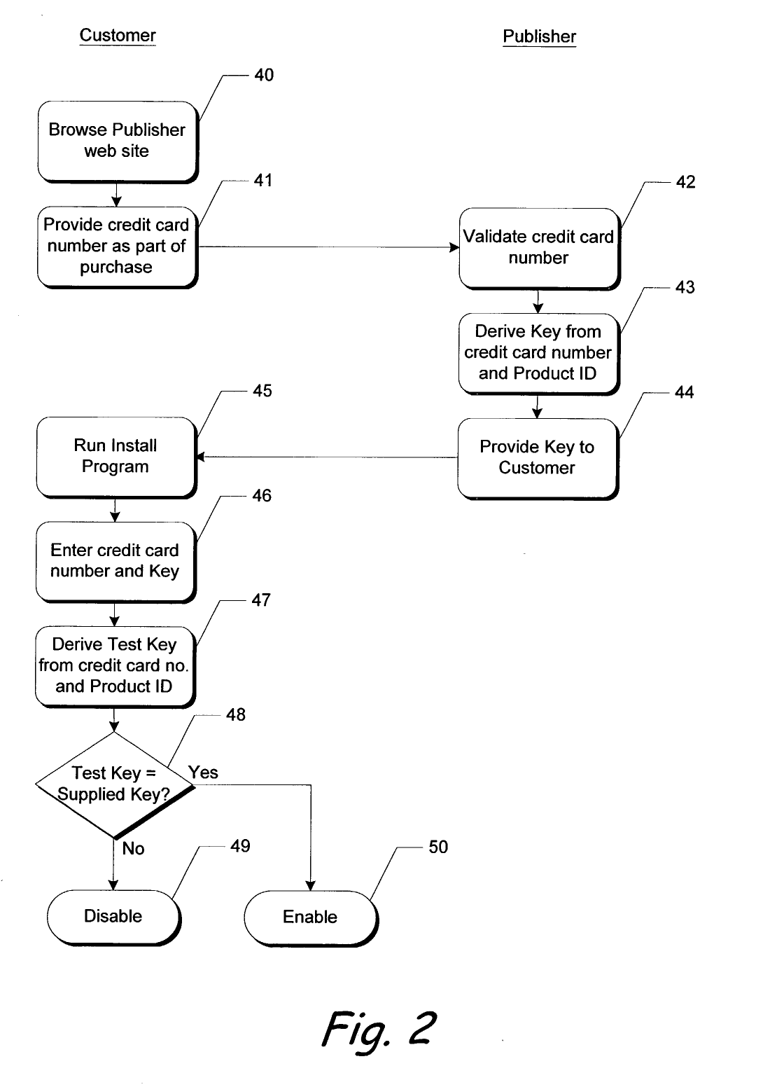

In FIG. 2 through FIG. 6, the customer is described as using a “computer.” As used herein, the term “computer” is intended to mean essentially any type of device or machine that is capable of running software, including standard “IBM PC-compatible” and Apple Macintosh computers, UNIX workstations, and also such devices as pagers, telephones, electronic books, hand-held computers, personal digital assistants, web-enabled televisions, home automation systems, multi-media viewing systems, satellite and cable TV receivers, portable media players, e-book readers, etc. Although the description assumes the “computer” used for accessing the publisher's web site and the “computer” that runs the intellectual property are the same device, they could be two separate devices, alike or different, such as a personal computer and a portable music player. The component described for discussion purposes as the publisher's “web site” could be any form of standard web site, or any other catalog or distribution system suitable for interfacing with the customer's computer and implemented with any combination of hardware and software appropriate to the publisher's business. For discussion purposes, the customer computer is assumed to have a “browser” capable of accessing the publisher's web site. The browser may be any standard browser such as Microsoft Internet Explorer or Netscape Navigator, or a component designed specifically to interface with the publisher's catalog or distribution system, such as a media player with an integrated entertainment purchasing function. In addition, the customer's access to the publisher's “web site” may be implemented in many different forms, such as the Internet, an intranet or private network, or a local or wide area network, including both wire-based networks (e.g., cable, telephone, fiber optic, etc.) and wireless networks (e.g., RF, satellite, microwave, etc.). “Publisher” is used to mean any entity that distributes intellectual property legitimately, such as the owner of the intellectual property, a distributor, a retailer, an authorized portal, and so forth.

The description makes use of a credit card number as an example of the Private Information. Nothing in the invention, however, requires that that credit card number actually be used to purchase the intellectual property license, only that the publisher have some means of validating the credit card number or other Private Information, and the user be extremely reluctant to share the Private Information with friends and strangers. The intellectual property license could be purchased with any form of currency—such as cash, check, or a different credit card—or could even be free. In many cases, such as limited prepublication releases of software, publishers may wish to use the invention to control the proliferation of intellectual property even though they do not charge for it.

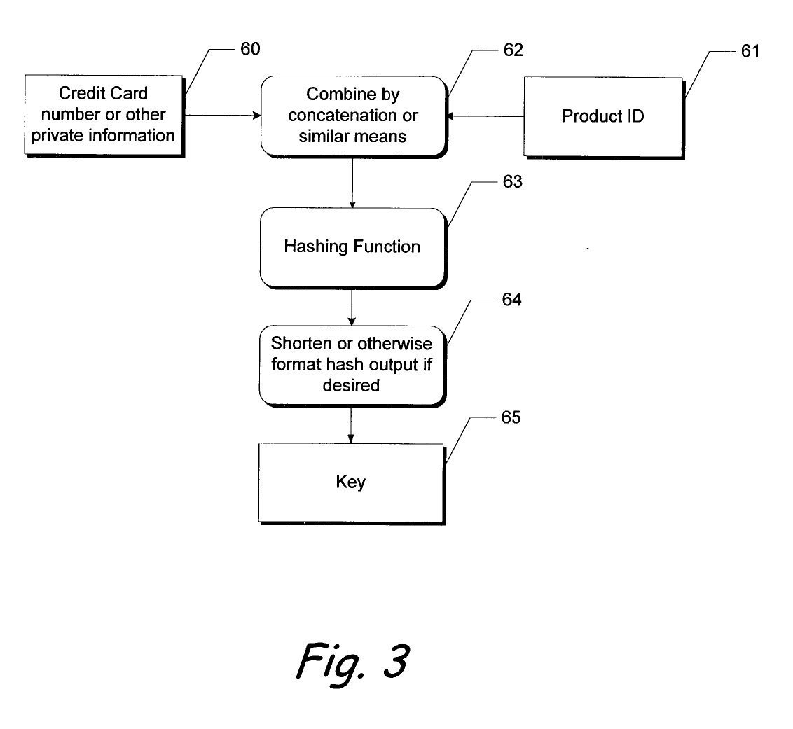

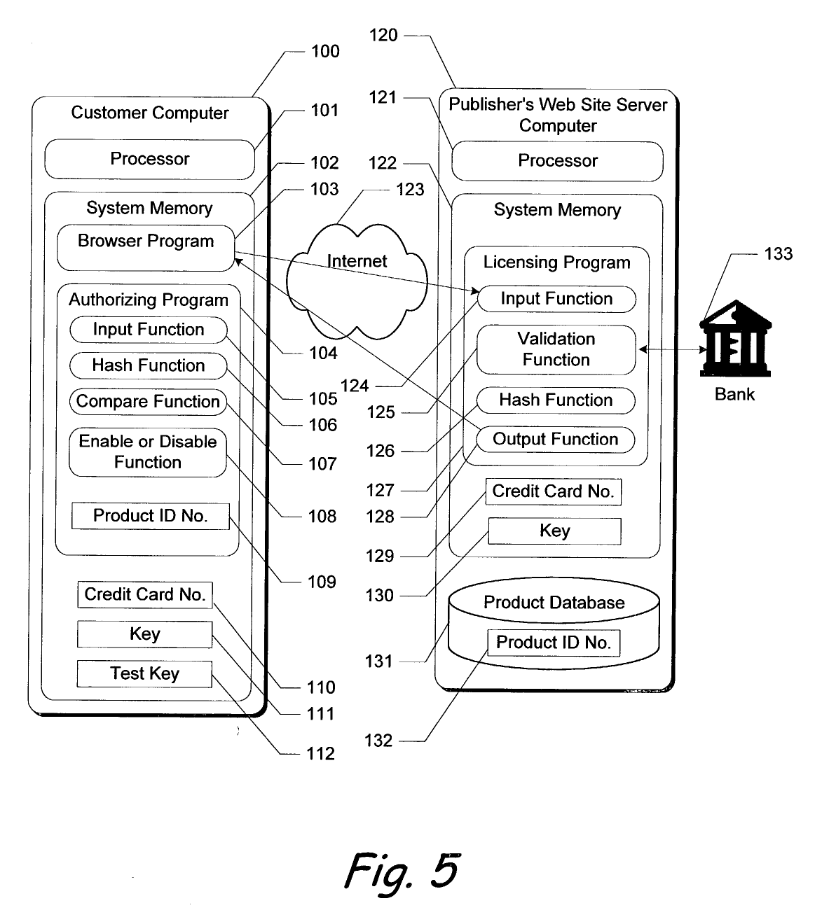

In FIG. 2, FIG. 3 and FIG. 5 reference is made to a Product ID Number. The Product ID Number is necessary to uniquely identify the intellectual property that is being licensed. Although it is called for discussion purposes a “number,” it could be any alphabetic, numeric or binary (or any combination) string long enough to provide a unique identification of every intellectual property “product” in the publisher's repertoire. A unique ID for every product is necessary so that the customer's purchase of one product does not also grant the customer access to any other product. Note however, that it need only be unique to each separately-licensed product (such as Microsoft Word) and need not be unique to each copy of the product. This is an important distinction because it facilitates the bulk manufacture and distribution of product CDs and similar media. Also, the Product ID Number may identify, and the invention may therefore be used to control the licensing of, not only a “product” in the conventional sense (such as Microsoft Word) but also any intellectual property right such as “the right to use the Spanish language spell checker in Microsoft Word on one handheld computer during the period from June 1 to Jun. 30, 2002.” The Product ID Number must be firmly “bound” to the distributed product package, so that the customer cannot substitute the ID of a previously-licensed product into a product that the customer wishes to enable unscrupulously. The most obvious method would be to compile the ID—possibly “masked” to discourage discovery—into the product's executable program code during its development, but the ID number could also be packaged with the product in any other manner that was sufficiently resistant to tampering.

FIG. 2 shows an exemplary method of a customer obtaining an intellectual property product license from a publisher who uses the invention in the mode of a publisher-generated key that is derived from and serves to validate the private information, in this example a credit card number. The customer uses a computer and browser to access the publisher's web site 40 and decides to obtain a license for the product. (The terms computer, web site, browser and publisher have the meanings discussed above.) The customer enters a credit card number into the publisher's web site as part of the purchase 41. The publisher's system validates the supplied credit card number through the publisher's bank or other means 42, and presumably charges the credit card for the cost of the license. The publisher's web site derives a Key by hashing the customer's credit card number and the Product ID Number 43. (The hashing process is detailed in FIG. 3.) The publisher's web site displays the Key, or emails it, or otherwise conveys it or makes it available to the customer 44. The product itself may be downloaded by the customer, or may be made available to the customer by other means, such as a CD or a download web site. The customer runs the product's installation program on a computer 45. The installation program prompts the customer for the credit card number (the same credit card number used for the purchase) and the publisher-supplied Key 46. The installation program derives a Test Key by hashing (using the same function as step 43) the supplied credit card number and the Product ID Number (which is embedded in or distributed with the product) 47. The installation program compares the derived Test Key with the publisher-supplied key as entered by the customer 48. If an unscrupulous person is attempting to install the product without the credit card number used to purchase the license, then the two keys are different (i.e., the “No” branch from 48) and operation or usage of the product is disabled 49. If the legitimate purchaser of the license is installing the product and enters the credit card number used for the purchase, then the two keys are identical (i.e., the “Yes” branch from 48) and operation or usage of the product is enabled 50.

FIG. 3 shows a block diagram of the detail of the hashing function referred to in steps 43 and 47 of FIG. 2. The distribution and installation programs combine the credit card number or other private information 60 with the Product ID Number of the product being distributed 61. In the distribution program (step 43 of FIG. 2), the product identification number is obtained from a product database or a similar source. In the installation program (step 47 of FIG. 2) the product identification number is embedded in or otherwise bound to the product to be installed as described above. The private information and Product ID Number are combined into a single piece of data by concatenation, exclusive-ORing, or other means 62. The combined data is then hashed 63 using any available strong hash function such as the National Institute for Standards Technology Secure Hash Algorithm. The output of the hash function may be shortened by truncation or by exclusive-ORing a portion of the output with the remainder of the output, or otherwise formatted for distribution as desired 64. The result is a Key 65 that is then used in steps 44, 46 and 48 of FIG. 2.

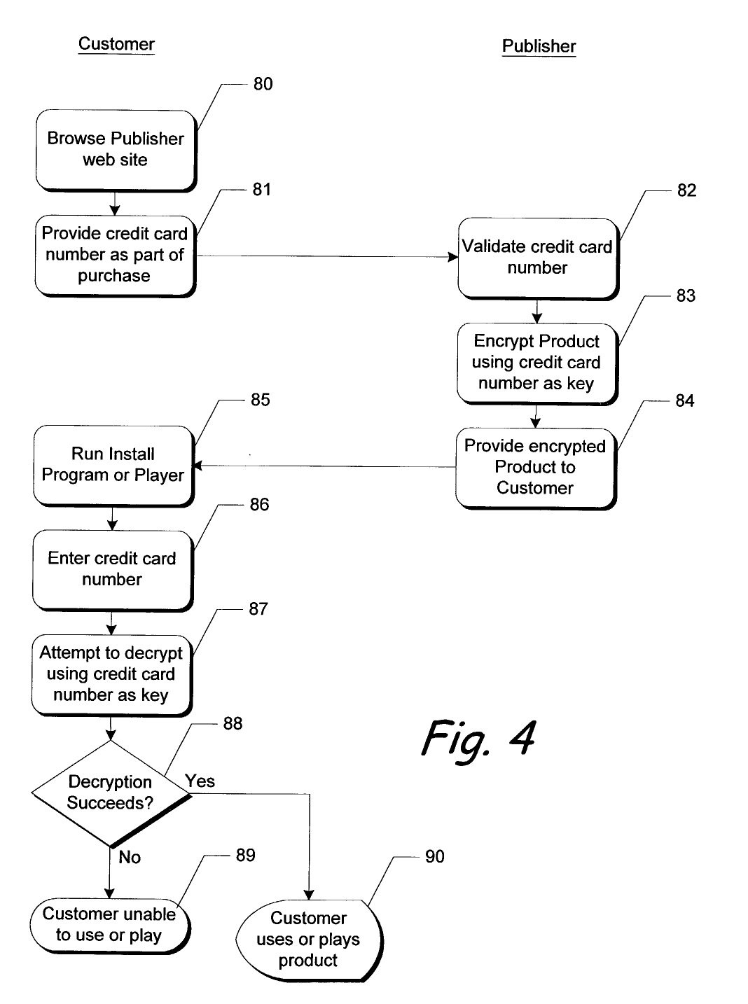

FIG. 4 shows an exemplary method of a customer obtaining an intellectual property product license from a publisher who uses the invention in the mode of encrypting the product with a key derived from the private information, in this example a credit card number. The customer uses a computer and browser to access the publisher's web site 80 and decides to obtain a license for the product. (The terms computer, web site, browser and publisher have the meanings discussed above.) The customer enters a credit card number into the publisher's web site as part of the purchase 81. The publisher's web site validates the supplied credit card number through the publisher's bank or other means 82, and presumably charges the credit card for the cost of the license. The publisher's web site encrypts the intellectual property product using as a key the customer's credit card number, or a value directly derived from the credit card number 83. The encryption may be any available secret key (sometimes called “symmetrical”) encryption of at least moderate strength such as the Federal Information Processing Standard Advanced Encryption Standard. The encrypted product is then transmitted to, or made available for download by, the customer 84. The customer runs the product's installation program or media player on a computer 85. The installation program or player prompts the customer for the credit card number 86 (the same credit card number used for the purchase) or has the credit card number stored as part of its customization options. The installation program or player attempts to decrypt the encrypted intellectual property product using as a key the customer's credit card number, or a value directly derived (in a fashion identical to that in step 83) from the credit card number 87. If an unscrupulous person is attempting to use or play the product without the credit card number used to purchase the license, then the decryption fails (i.e., the “No” branch from 88) and the unscrupulous person is unable to use or play the product 89. If the legitimate purchaser of the license is attempting to use or play the product with the credit card number used for the purchase, then the encryption succeeds (i.e., the “Yes” branch from 88) and usage or playing of the product is enabled 90.

FIG. 5 shows an exemplary anti-piracy system that implements the invention in the mode of a publisher-generated key that is derived from and serves to validate the private information, in this example a credit card number. (The terms computer, web site, browser and publisher have the meanings discussed above.) A customer computer 100 includes a processor 101 and system memory 102. The customer may run a browser program 103 to access a publisher's web site server computer 120 and a licensing computer software program 127 therein. The publisher's web server computer 120 includes a processor 121 and system memory 122 in which the licensing program 127 runs. Using the browser program 103, the customer may input his or her credit card number into the licensing program's input function 124 via the Internet 123. The input function 124 stores the credit card number 129 in system memory 122. The licensing program 127 includes a validation function 125 that validates the credit card number 129 with the publisher's bank 133, and presumably charges the credit card for the cost of the license. The licensing program 127 includes a hash function 126 that processes the credit card number 129 and the product ID number 132 of the purchased intellectual property product from a product database 131 to produce a key 130 that is stored in system memory 122 and displayed by an output function 128 via the Internet 123 in the browser program 103. The hash function 126 operates by combining the credit card number 129 and the product ID number 132 into a single piece of data by concatenation, exclusive-ORing, or other means. The combined data is then hashed using any available strong hash function such as the National Institute for Standards Technology Secure Hash Algorithm. The output of the hash function is shortened and formatted for transmission by truncation or by exclusive-ORing a portion of the output with the remainder of the output.

The customer may run an authorizing computer software program 104 to enable the licensed intellectual property product. The authorizing program includes an input function 105 into which the customer may type the key displayed by the licensing program 127 and a credit card number. The input function 105 stores the credit card number 110 and the key 111 in the system memory 102. The authorizing program 104 includes a hash function 106 that is equivalent in operation to the licensing program hash function 126. The hash function 106 processes the credit card number 110 and a product ID 109 contained in the authorizing program 104 to produce a test key 112 that is also stored in system memory 102. If the credit card number 110 and the product ID 109 are the same as those processed by the licensing program 127 then the key 111 and the test key 112 will be equal; if either one is different then the key 111 and the test key 112 will be different. A compare function 107 compares the key 111 with the test key 112. If they are equal then the enable or disable function 108 enables the use of the intellectual property; if they are different then the enable or disable function 108 disables the use of the intellectual property. Thus an unscrupulous person not in possession of the credit card number is precluded from using the intellectual property.

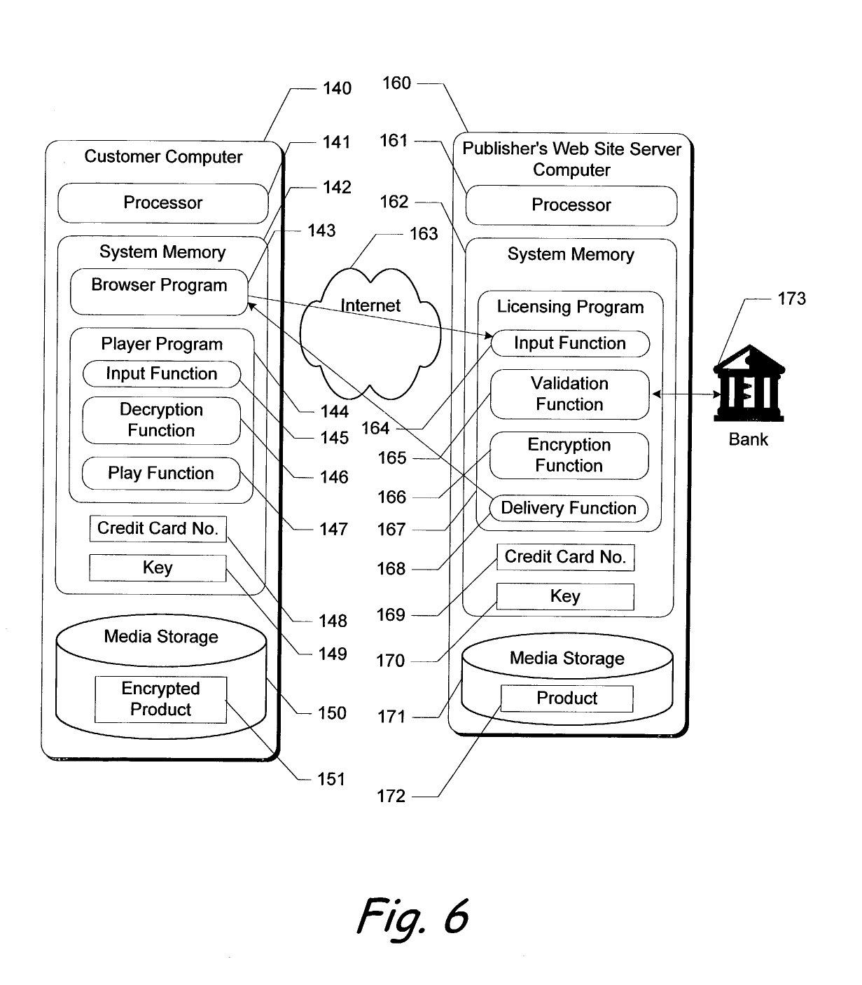

FIG. 6 shows an exemplary anti-piracy system that implements the invention in the mode in which a publisher encrypts the intellectual property product with a key derived from the private information, in this example a credit card number. (The terms computer, web site, browser and publisher have the meanings discussed above.) A customer computer 140 includes a processor 141 and system memory 142. The customer may run a browser program 143 to access a publisher's web site server computer 160 and a licensing computer software program 167 therein. The publisher's web server computer 160 includes a processor 161 and system memory 162 in which the licensing program 167 runs. The publisher's web server computer 160 keeps each intellectual property product 172 in a media storage file or database 171. Using the browser program 143, the customer may input his or her credit card number into the licensing program's input function 164 via the Internet 163. The input function 164 stores the credit card number 169 in system memory 162. The licensing program 167 includes a validation function 165 that validates the credit card number 169 with the publisher's bank 173, and presumably charges the credit card for the cost of the license. The licensing program 167 derives a key 170 from the credit card number 169 and stores it in system memory 162. The licensing program 167 includes an encryption function 166 that encrypts the intellectual property product 172 with the key 170 and a delivery function 168 that transmits the encrypted product via the Internet 163 to the customer computer 140 for storage in its media storage file or database 150 as an encrypted product 151. The encryption may be any available secret key (sometimes called “symmetrical”) encryption of at least moderate strength such as the Federal Information Processing Standard Advanced Encryption Standard.

The customer may run a media player computer software program 144 to play the encrypted intellectual property product 151. The player program includes an input function 145 into which the customer may type a credit card number. The input function 145 stores the credit card number 148 in the system memory 142. The player program 144 derives a key 149 from the credit card number 148 in the same way as the licensing program 167 and stores it in system memory 142. The player program 144 includes a decryption function 146 (complementary in function to the encryption function 166) that attempts to decrypt the encrypted product 151 with the key 149. If and only if the credit card number 148 is the same as the credit card number 169 used to license and encrypt the product will the decryption function 146 be successful. The player program includes a play function 147 that enables the customer to enjoy the intellectual property product. Conversely an unscrupulous person not in possession of the credit card number 169 is precluded from decrypting and enjoying the intellectual property even if a licensed customer has previously shared the encrypted product 151 with him or her.

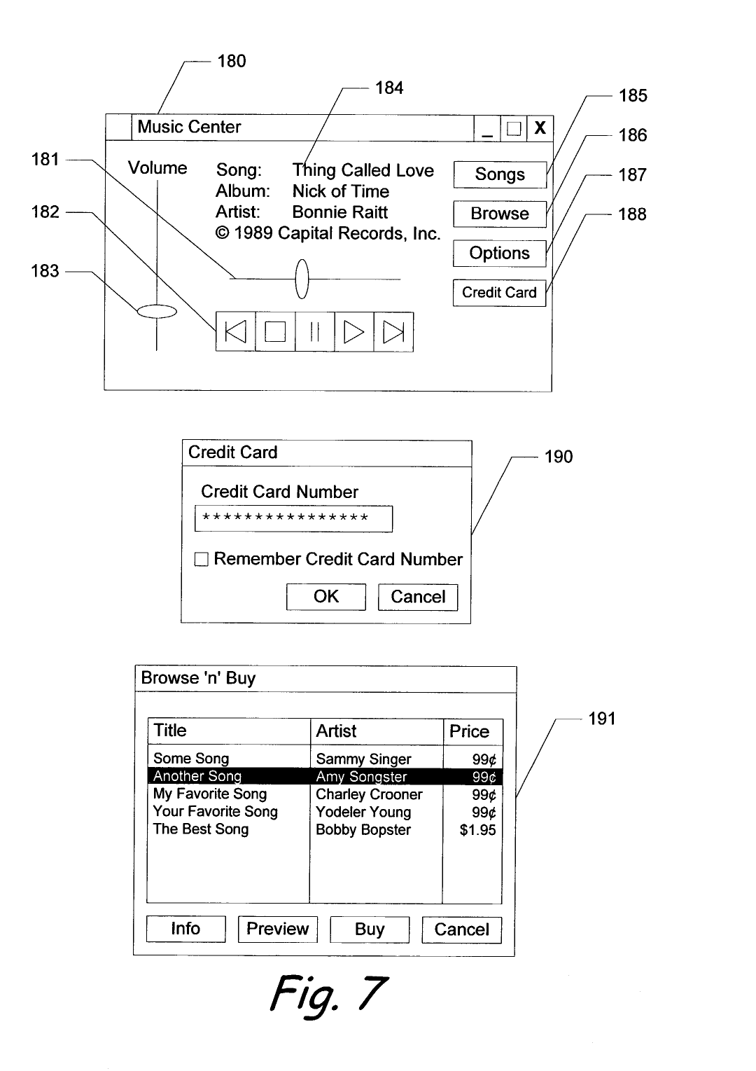

FIG. 7 illustrates the user interface of an embodiment of the invention in the mode in which a publisher encrypts the intellectual property product with a key derived from the private information, in this example a credit card number. FIG. 7 shows the main screen 180 of a music player that integrates the browser and player components of the invention in a single computer software program. The program runs on a computer, that is essentially any type of device or machine that is capable of running software, including standard “IBM PC-compatible” and Apple Macintosh computers, UNIX workstations, and also such devices as pagers, telephones, electronic books, hand-held computers, personal digital assistants, web-enabled televisions, home automation systems, multi-media viewing systems, satellite and cable TV receivers, portable media players, e-book readers, etc. The main screen 180 includes a bar that indicates the relative progress of playback 181, the standard rewind, stop, pause, play and fast forward buttons 182, a volume control slider 183 and a description of the song currently being played 184. The main screen 180 includes buttons for displaying subordinate screens: a button to display a list of previously-licensed songs available for play 185, a button to access a publisher's list of songs available for license 186, a button to invoke a screen for setting miscellaneous options 187, and a button to display a credit card number entry panel 188.

The credit card number entry panel 190 includes a field in which the customer types his or her credit card number. The credit card number is used both to pay for music licenses and for decrypting downloaded songs. The credit card number is “masked” during entry to prevent others from seeing it, a standard programming technique. The credit card number entry panel includes an option to have the program remember the customer's credit card number, or to require that the customer enter it every time he or she uses the player.

The Browse and Buy panel 191 shows a list of songs available for license and download from a particular publisher or distributor, along with the license fee for each. The music player communicates over the Internet with one or more publishers' server computers offering lists of songs available for download and license. Buttons allow the customer to obtain additional information about songs; to hear a short, low-fidelity preview; to purchase a license and download one or more songs; or to return to the main screen without buying any license.

What is claimed is:

1. A method for protecting intellectual property distributed in digital form from unauthorized sharing, transfer, or re-distribution, comprising:
(a) providing for validating some distinctive private information possessed by an intended recipient of said intellectual property, and
(b) providing a licensing computer software program comprising:
(1) inputting into computer memory said private information, and
(2) combining said private information with an identification of said intellectual property into a key value that is derived from said private information and said identification, said value being distinctive and not readily guessed, deduced, or factored, and
(3) outputting said value, and
(c) providing for distributing or making available said key value and said intellectual property containing said identification to said intended recipient, and
(d) providing an authorizing computer software program or function comprising:
(1) said authorized user inputting into computer memory said key value and said private information, and
(2) combining said private information with said identification into a test value that is derived from said private information and said identification in the same manner as in said licensing computer software program, and
(3) comparing said key value with said test value, and
(4) enabling access to said specific intellectual property if and only if said values agree,
whereby said recipient is precluded from sharing with others or transferring or re-distributing to others said intellectual property because to do so would require disclosing said private information.

2. A method for protecting intellectual property distributed in digital form from unauthorized sharing, transfer, or re-distribution comprising:
(a) providing for validating some distinctive private information possessed by an intended recipient of said intellectual property, and
(b) providing a licensing program comprising
(1) inputting into computer memory said private information, and
(2) encrypting said intellectual property using a key consisting of or derived from said private information, and
(c) providing for distributing or making available the encrypted intellectual property to said intended recipient, and
(d) providing an authorizing program or function comprising
(1) said authorized user inputting into computer memory said private information, and
(2) decrypting said encrypted intellectual property using a key consisting of or derived from said private information in the same manner as said encrypting key
whereby said recipient is precluded from sharing with others or transferring or re-distributing to others said intellectual property because to do so would require disclosing said private information.

3. A computer software product for protecting intellectual property distributed in digital form from unauthorized sharing, transfer, or redistribution, comprising:
(a) a licensing program comprising:
(1) inputting into computer memory some validated distinctive private information possessed by an intended recipient of said intellectual property, and
(2) combining said private information with an identification of said intellectual property into a key value that is derived from said private information and said identification, said value being distinctive and not readily guessed, deduced, or factored, and
(3) outputting said key value in a manner suitable for distribution to said recipient, and
(b) an authorizing program or function comprising
(1) said authorized user inputting into computer memory said key value and said private information, and
(2) combining said private information with said identification into a test value that is derived from said private information and said identification in the same manner as in said licensing computer software program, and
(3) comparing said key value with said test value, and
(4) enabling access to said specific intellectual property if and only if said values agree,
whereby said recipient is precluded from sharing with others or transferring or re-distributing to others said intellectual property because to do so would require disclosing said private information.

4. A computer software product for protecting intellectual property distributed in digital form from unauthorized sharing, transfer, or redistribution, comprising:
(a) a licensing program comprising
(1) inputting into computer memory some validated unique private information possessed by an intended recipient of said intellectual property, and
(2) encrypting said intellectual property using a key consisting of or derived from said private information, and
(3) outputting the encrypted intellectual property in a form suitable for distribution, and
(b) an authorizing program or function comprising:
(1) said authorized user inputting into computer memory said private information, and
(2) decrypting said encrypted intellectual property using a key consisting of or derived from said private information in the same manner as said encrypting key
whereby said recipient is precluded from sharing with others or transferring or re-distributing to others said intellectual property with others because to do so would require disclosing said private information.
